(19) United States
(12) Patent Application Publication
(10) Pub. No.: US 2009/0127065 A1
(43) Pub. Date: May 21, 2009

(54) COIN BANK WITH AUTOMATED MEANS FOR DEPOSITING GROUPS OF COINS

(76) Inventor: Marshall S. Hacker, Los Angeles, CA (US)

Correspondence Address: CHRISTIE, PARKER & HALE, LLP, PO BOX 7068, PASADENA, CA, 91109-7068, US

(21) Appl. No.: 11/941,783

(22) Filed: Nov. 16, 2007

(51) Int. Cl. G07F 1/04; G06M 1/00

(52) U.S. Cl. 194/215; 194/344

(57) ABSTRACT

A coin bank with an automated means for depositing groups of coins is provided. In one embodiment, the invention relates to a coin bank for storing money, including a vessel configured to store at least one coin, where the vessel includes an opening, a means for receiving the at least one coin in a first position, the receiving means having a first hinge at a first end and a second hinge at a second end, and an actuating means for moving the receiving means from the first position to a second position, the actuating means in contact with the receiving means and the vessel, wherein the opening is configured to receive the at least one coin in the second position.

### BACKGROUND OF THE INVENTION

Coin banks have generally been directed to children to encourage the practice of saving money at a young age. To that end, coin banks have often incorporated kinetic motion and aesthetic features to attract the attention of young children. Often the inclusion of such motion has resulted in sacrifices in utility. Due to the intricacy of these designs, coin banks have commonly been limited to the deposit of a single coin at a time. However, single deposit coin banks are somewhat limited and consequently discourage adults and older children from using the banks as practical savings devices. As a result, such coin banks often sacrifice utility for the sake of attracting young children and fail to appeal to adults or older children.

### SUMMARY OF THE INVENTION

Aspects of the present invention relate to a coin bank with an automated means for depositing groups of coins. In one embodiment, the invention relates to a coin bank for storing money, including a vessel configured to store at least one coin, where the vessel includes an opening, a means for receiving the at least one coin in a first position, the receiving means having a first hinge at a first end and a second hinge at a second end, and an actuating means for moving the receiving means from the first position to a second position, the actuating means in contact with the receiving means and the vessel, wherein the opening is configured to receive the at least one coin in the second position.

In another embodiment, the invention relates to a coin bank for storing money, including a vessel configured to store at least one coin, where the vessel includes an opening, a means for receiving the at least one coin in a first position, the receiving means having a first hinge at a first end, a means for receiving paper currency; and an actuating means for moving the receiving means from the first position to a second position, the actuating means in contact with the receiving means and the vessel, wherein the opening is configured to receive the at least one coin in the second position.

In yet another embodiment, the invention relates to a method for storing money in a coin bank, the method including providing a vessel configured to store at least one coin, providing a receiving means configured to receive the at least one coin, the receiving means having a first hinge and a second hinge, moving the receiving means from a first position to a second position to deposit the at least one coin into the vessel, wherein the moving the receiving means comprises moving the first hinge from a third position to a fourth position, and wherein the moving the receiving means comprises moving the second hinge from a fifth position to a sixth position.

### BRIEF DESCRIPTION OF THE DRAWINGS

FIG. 1 is a perspective view of a coin bank in accordance with one embodiment of the present invention;

FIG. 2 is a perspective view of the coin bank of FIG. 1 having the receiving means locked into place on the vessel;

FIG. 3 is a perspective view of a coin bank having a receptacle plate with a single hinge in accordance with one embodiment of the present invention;

FIG. 4 is a perspective view of the coin bank of FIG. 3 having the receptacle plate locked in place with a release button;

FIG. 5 is a front view of a receptacle plate having multiple coin storage cylinders in accordance with one embodiment of the present invention;

FIG. 6 is a perspective view of a coin bank having multiple coin deposit slots and an integrated electronics board in accordance with one embodiment of the present invention;

FIG. 7 illustrates a front view of the integrated electronics board of FIG. 6;

FIG. 8 illustrates a back view of the integrated electronics board of FIG. 6;

FIG. 9 is a flowchart illustrating the operation of the integrated electronics board of FIG. 6 in accordance with one embodiment of the present invention; and

FIG. 10 is a table illustrating sequences by which the LEDs of FIG. 9 can be controlled to emit light.

### DETAILED DESCRIPTION OF THE INVENTION

Embodiments of coin banks described herein appeal to a broad audience by including features attractive to children, such as motion, lights and sound, while retaining the utility appreciated by adults and older children. In some embodiments, methods and apparatus are provided for concurrently depositing groups of coins into an enclosed vessel. In some embodiments, coins are deposited into the vessel from a receiving means when a user presses a release button that causes the receiving means to be moved from a first position to a second position.

Depositing groups of coins simultaneously can encourage children to save at an early age, while also appealing to adults and older children. In some embodiments, the deposit of coins or currency is accompanied by attention-grabbing lights and sound. The incorporated lights and sounds further encourage children to appreciate the practice of saving, as well as provide adults and older children with valuable information regarding progress toward their savings goals.

Due to the broad appeal of the coin banks described herein, they can be used in a variety of commercial and philanthropic settings. In the commercial setting, the coin banks can be useful as novelty items for sale to the general public, or as a promotional item for sale to a company that can use them as part of an advertising and promotional scheme. In addition, as the banks are capable of depositing several coins at a time, the coin banks can be particularly relevant in fund-raising, enabling easy and efficient collection of donations by schools, religious organizations, charitable organizations, etc. The coin banks can also be used as a promotional item for any company, organization, or cause, including, but not limited to, banks, credit unions and other savings organizations.

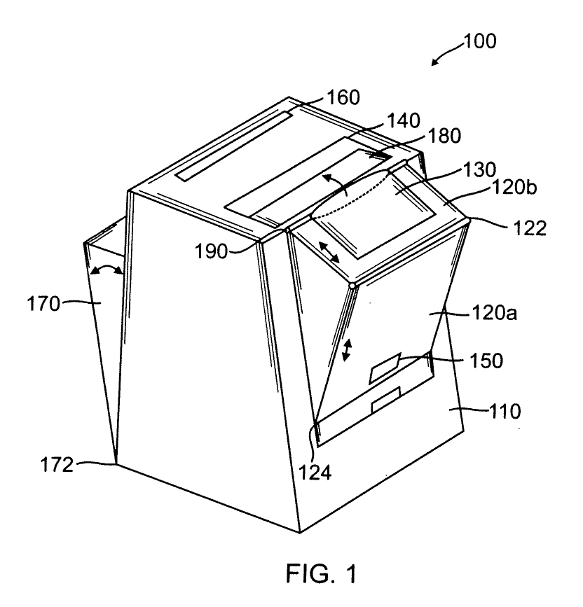

FIG. 1 is a perspective view of a coin bank 100 in accordance with one embodiment of the present invention. The bank includes a main vessel 110 and a receiving means including a bottom receptacle plate 120a and a top receptacle plate 120b. The main vessel includes a first opening 140, an access door 180, a second opening 160 and a second vessel 170. The top receptacle plate 120b includes a coin receptacle 130 capable of receiving multiple coins, a moveable hinge 122 and a spring biased hinge 190. The top receptacle plate 120b is coupled to the bottom receptacle plate by the moveable hinge 122 and to the vessel by the spring biased hinge 190. In one embodiment, the bottom receptacle plate 120a includes a release button 150 and an articulating hinge 124. The bottom receptacle plate 120a is coupled to the vessel by the articulating hinge 124. In the illustrated embodiment, the articulating hinge 124 is capable of moving from one position on the vessel to another position on the vessel. In another embodiment, the bottom receptacle plate 120a includes a release button 150 but no articulating hinge. In this embodiment, the bottom receptacle plate 120a is not coupled to the vessel, but rather, rests against the vessel and slides against the vessel in response to movement of the moveable hinge 122 and spring biased hinge 190.

The main vessel 110 includes an internal cavity for storing coins or currency deposited by the receiving means or another means. The coin receptacle 130 can be attached to the receptacle plate or can be integral to the receptacle plate and is configured to hold more than one coin. To deposit the contents of the coin receptacle 130 into the cavity of the vessel 110, the receiving means is mechanically rotated about an axis, resulting in the up-ending of the coin receptacle 130 and the emptying of its contents through an opening 140 in the vessel 110 into the cavity of the vessel 110.

Rotation of the receiving means (120a, 120b) to deposit the contents of the coin receptacle 130 can be achieved using a number of suitable mechanisms. In the illustrated embodiment, for example, the rotation is accomplished by a spring-biased hinge 190.

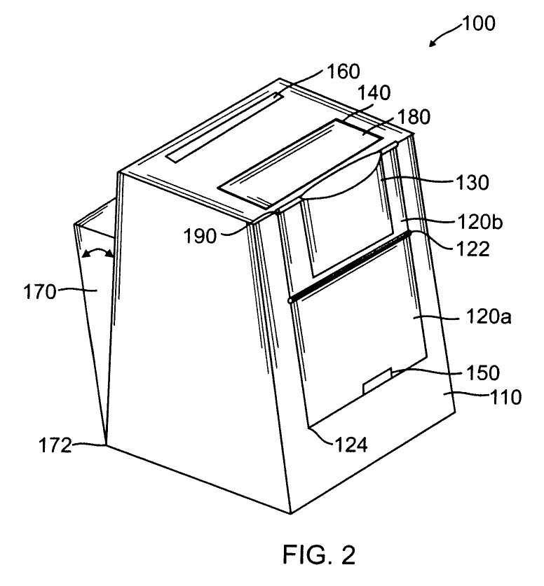

In operation, the receiving means (120a, 120b) is held in a locked position against the vessel 110 by release button 150. In the locked position, the coin receptacle 130 can receive coins or other objects. FIG. 2 is a perspective view of the coin bank of FIG. 1 having the receiving means locked into place on the vessel. After placing coins or other objects into the coin receptacle, the user presses the release button 150. After the button is pressed, the spring-biased hinge 190 forces the receiving means from the locked or extended position, which is flush against the vessel. As shown in FIG. 1, upon the release of the receiving means, the spring-biased hinge 190 forces the top receptacle plate 120b to rotate about an axis along the length of the spring biased hinge 190. The movement of the top receptacle plate forces the bottom side of the bottom receptacle plate to move along the body of the vessel. When the top receptacle plate is rotated such that the movable hinge 122 is higher in elevation than the spring biased hinge 190, the contents of the receptacle 130 are deposited through opening 140 into the main vessel 110. In other embodiments, the receiving means can operate in a different manner, and preferably such that it moves to deposit any coins within the coin receptacle.

In the locked position, the release button 150 on the vessel 110 releasably grasps or holds one end of the receiving means (120a, 120b) to the vessel 110, thereby preventing the spring-biased hinge 190 from forcing the receiving means upward toward the opening 140 in the vessel 110. In the illustrated embodiment, the button is on the bottom receptacle plate 120a and includes a mechanism for releasably attaching to the vessel. In another embodiment, the button is on the vessel and includes a mechanism for retaining the receiving means.

In the illustrated embodiment, the door 180 of the vessel 110 remains closed when the receiving means is in the locked position. The door 180 can prevent access to the cavity of the vessel when coins are not being deposited. More specifically, the door can prevent the contents of the cavity from exiting through the opening 140 if the bank is dropped or inverted by mistake. The door 180 can be actuated using a number of different means. In one embodiment, for example, the door 180 is coupled to the receiving means via the spring-biased hinge 190. In such case, the door is opened as the receiving means is moved from the locked position to the deposit position. The coin bank user can return the receiving means to the locked position by pushing down on the top receptacle plate 120b. In such case, the door 180 can return to a closed position. In another embodiment, the door is coupled using another means such that the door opens when the receiving means is configured to release coins into the vessel. In one embodiment, the door 180 can include one or more coin slots for depositing any number of coins. In such case, the deposit of coins can be expedited.

The mechanism for controlling the position of the door 180 can take a number of suitable forms. In one embodiment, the door 180 can be attached to the vessel 110 by a separate spring-biased hinge (not shown) which forces the door downward upon the application of an external force, such as the weight of a group of coins. In such an embodiment, the coins are deposited directly on the door, which opens due to sufficient weight of the coins. When the door opens, the coins can fall through the opening 140 into the cavity of the vessel. In another embodiment, the door 180 can be connected to the vessel by way of another spring-biased hinge that is activated by a separate lever or button (not shown). In such an embodiment, the door and receiving means are activated by separate means, possibly using the activation of two buttons or levers to deposit coins into the cavity of the vessel.

In the illustrated embodiment, when the door 180 is closed, the opening 140 of the vessel 110 is closed, which blocks access to the cavity of the vessel 110. This prevents both deposit of coins into the vessel and extraction of coins from the vessel. When the door is open, the opening 140 allows access to the cavity, and coins can be either deposited into or extracted from the cavity of the vessel.

The receiving means can take a number of suitable shapes. For example, as shown in FIGS. 1 and 2, the receiving means can include top and bottom receptacle plates 120b and 120a, respectively, coupled to each other. The bottom receptacle plate 120a has one end releasably coupled to the vessel 110. The top receptacle plate 120b is coupled to the receptacle 130 for holding coins. In one embodiment, one end of the top receptacle plate 120b includes a spring-biased hinge 190. In such case, the top receptacle plate 120b rotates about the spring-biased hinge. This spring-biased hinge 190 can operate in the same fashion as described above. The other end of the top receptacle plate 120b is coupled to the bottom receptacle plate 120a by a loose or moveable hinge, such that upon the release of the coupling between the bottom receptacle plate 120a and the vessel 110, the moveable hinge allows the top and bottom receptacle plates to rotate about the moveable hinge as the spring-biased hinge forces the top and bottom receptacle plates upward. This action biases the top receptacle plate 120b toward the opening 140 in the vessel 110.

In another embodiment, the receiving means and/or receptacle can include shapes having appeal to children or possibly adults. For example, the receptacle can take the shape of a box such as a common cereal box. In such case, coins can be deposited into the box top. In another embodiment, the receiving means can take the shape of a soft drink can or soft drink bottle. In other embodiments, other shapes popular among children can be used for the receptacle.

The coin bank can be made from any number of materials, including metal, metal composites, plastic and/or other suitable materials. The receiving means can be made from any number of materials, including metal, metal composites, plastic and/or other suitable materials.

In one embodiment, the coin bank includes a coin release means for emptying the coins stored within the bank. In one embodiment, the coin release means includes an opening on the bottom of the coin bank and a plug like device for sealing the opening during normal operation and for removal resulting in quick release of the coin bank contents. In another embodiment, the coin release means includes an opening on the bottom of the coin bank and a door blocking the opening that is normally closed during use of the coin bank. In such case, the door can be released or opened when the user wishes to empty the contents of the bank. In one embodiment, the door is secured to the bottom of the coin bank using a hinge. In another embodiment, the bottom is a hinged door and can be released. In yet another embodiment, the release of the door can be controlled by a security means. In such case, the door can prevent unauthorized release of coins.

In one embodiment, the security means is a key. In another embodiment, the security means is a electronic lock requiring a security code.

As shown in FIGS. 1 and 2, the vessel can include a second opening 160. This opening can be used for depositing paper currency or other items into the vessel 110. The vessel 110 can include a separate cavity 170 (separate from the cavity for receiving coins) for receiving paper currency from the second opening 160. In one embodiment, the paper currency is folded in half and then inserted into the opening 160. By inserting the bills with the crease at the bottom, a large number of bills can be inserted into the storage compartment. In other embodiments, the paper currency can be inserted into the opening 160 in other forms. For example, the bills can be inserted with the crease at the top.

In one embodiment, the second opening 160 and separate compartment 170 can be located along a side of the vessel 110 opposite the opening 140. The separate compartment 170 can have a hinged bin with a lower end including a hinge about which the bin rotates. An upper end of the bin can be pulled away from the vessel 110, forcing rotation of the first end about the hinge, thereby exposing the inside of the separate compartment 170 for insertion and extraction of the paper currency.

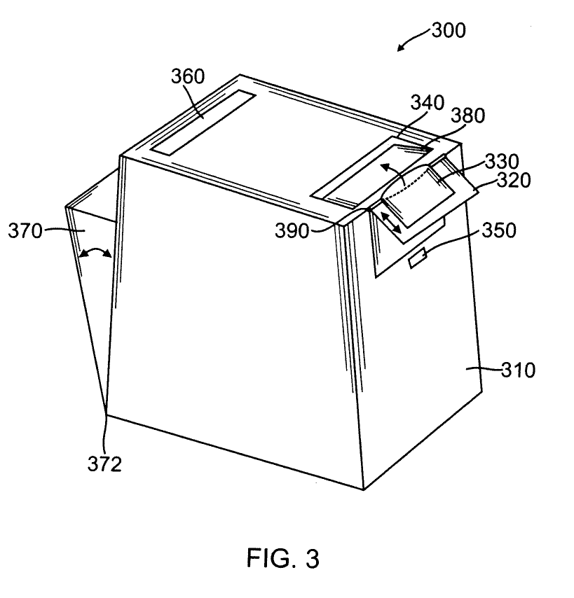

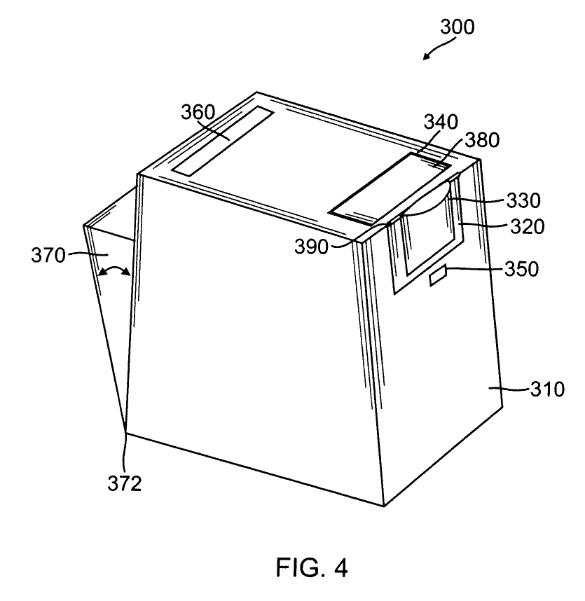

FIG. 3 is a perspective view of a coin bank 300 having a receptacle plate with a single hinge, in accordance with one embodiment of the present invention. FIG. 4 is a perspective view of the coin bank 300 of FIG. 3, in which the receptacle plate 320 is locked in place using a release button. As shown in FIGS. 3 and 4, the receiving means includes a single hinged plate 320 having a spring-biased hinge 390 at one end about which the hinged plate rotates. The other end of the hinged plate 320 is releasably attached to the vessel 310 by an attachment means 350. When the attachment means 350 is released, the spring-biased hinge 390 moves the hinged plate 320 upward toward the opening 340. This rotation deposits the contents of a receptacle 330 coupled to the hinged plate 320 into the opening 340 in the vessel 310.

In another embodiment, a motor can be used to move the receiving means from one position to another. In such case, an activation button can be mounted to the coin bank. When a user presses the activation button, the motor can move the receiving means. In one embodiment, the motor is a servo motor.

As shown in FIGS. 3 and 4, the vessel can include a second opening 360. This opening can be used for depositing paper currency or other items into the vessel 310. The vessel 310 can include a separate cavity 370 (separate from the cavity for receiving coins) for receiving paper currency from the second opening 360. In one embodiment, the paper currency is folded in half and then inserted into the opening 360. By inserting the bills with the crease at the bottom, a large number of bills can be inserted into the storage compartment. In other embodiments, the paper currency can be inserted into the opening 360 in other forms. For example, the bills can be inserted with the crease at the top.

In one embodiment, the second opening 360 and separate compartment 370 can be located at the side of the vessel 310 opposite the opening 340. The separate compartment 370 can have a hinged bin with a lower end including a hinge about which the bin rotates. An upper end of the bin can be pulled away from the vessel 310, forcing rotation of the first end about the hinge, thereby exposing the inside of the separate compartment 370 for extraction of the paper currency.

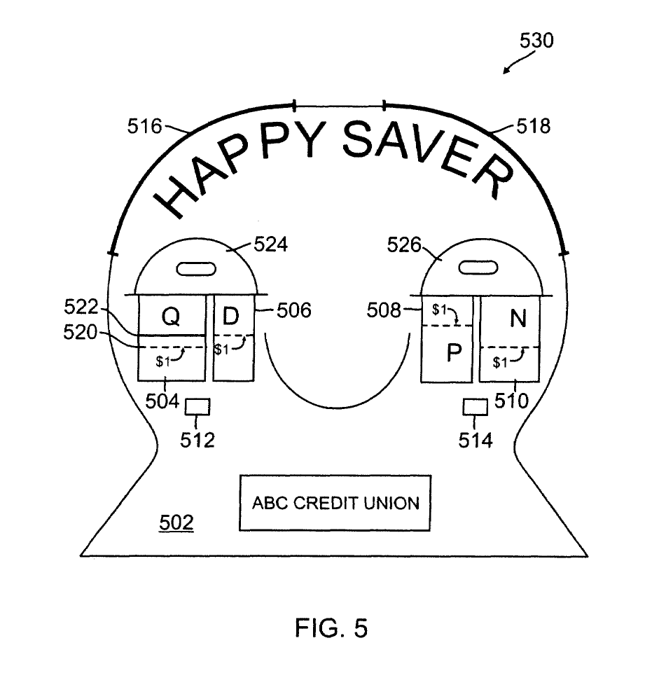

FIG. 5 is a front view of a receptacle 530 for a coin bank having multiple coin storage cylinders in accordance with one embodiment of the present invention. The receptacle 530 includes a receptacle plate 502, a quarter coin cylinder 504, a dime coin cylinder 506, a penny coin cylinder 508, a nickel coin cylinder 510, two release buttons (512, 514) and two guiding walls (516, 518). The quarter cylinder 504 is configured to receive a number of quarters in a stacked fashion, much like coins stacked in a roll of quarters. Similarly, the dime cylinder, penny cylinder and nickel cylinder are each configured to receive a number of dimes, pennies and nickels, respectively, in a stacked fashion.

Each coin cylinder has an opening at the top of the cylinder such that the coins can be inserted and stacked in the cylinder. Each coin cylinder is mounted to the receptacle plate 502 using any number of methods of attachment known in the art. In one embodiment, a mounting means is attached to the bottom of each cylinder and to the receptacle plate 502. In another embodiment, a securing band tightly grips the exterior of each cylinder near the center of the cylinder and attaches to the receptacle plate 502. Each coin cylinder can be made of a transparent material such as transparent plastic or another suitable material. The transparent material allows the user to see the height of stack of coins. Markings on each cylinder indicate particular monetary amounts stored in the cylinder. For example, in the illustrated embodiment, dashed horizontal lines for the quarter, penny and nickel cylinders correspond to one dollar (“$1”). In other embodiments, other monetary values can be marked. Any number of different types or styles of marking monetary values can be used.

In operation, the receptacle 530 can be used in conjunction with the coin bank embodiments of FIGS. 1 to 4. The receptacle 530 can be used in place of the receptacle 330 of FIGS. 3 and 4. In such case, a user can press the release button 350 and the spring-biased hinge 390 can force the receptacle to rotate upwards to deposit coins. Once rotated, gravity can cause the coins stored in the cylinders to fall into the opening 340 on the coin bank vessel. Guiding walls 516 and 518 extend outward from the top surface of receptacle plate and act to guide falling coins to a central portion between the walls such that the coins are ultimately deposited into the opening 340 of the coin bank.

In another embodiment, the quarter and dime coin cylinders are each mounted to a spring-biased hinge (not shown). The spring-biased hinge can rotate the two cylinders upward such that gravity empties the cylinders into an adjacent opening. In the illustrated embodiment, the left “eye” 524 can be the adjacent opening for deposit of the quarter and dime cylinders. A left release button 512 can release the quarter and dime cylinders and allow the spring-biased hinge to rotate the cylinders. Similarly, the penny and nickel coin cylinders can each be mounted to a spring-biased hinge (not shown). The spring-biased hinge can rotate the penny and nickel cylinders upward such that gravity empties the cylinders into an opening at the right “eye” 526. A right release button 514 can release the two cylinders and allow the spring-biased hinge to rotate the cylinders. The openings in the “eyes” can correspond to openings on the vessel 310 such that coins from the cylinders ultimately are deposited within the vessel.

In one embodiment of the present invention, the bank includes electronic circuitry configured to issue audible sounds which encourage saving or provide information regarding the coin bank, the contents of the bank, or the value of the money being placed in the bank. In such case, coins deposited into the coin bank activate a switch or sensor that determines the values of the coins deposited and adds the values in an electronic summing register. The bank can separate the coins for deposit into individual slots designated for each value of coin or, in an alternate embodiment, the bank can deposit all of the coins into a single coin slot system which then determines the value of each particular coin and adds that value to the electronic summing register.

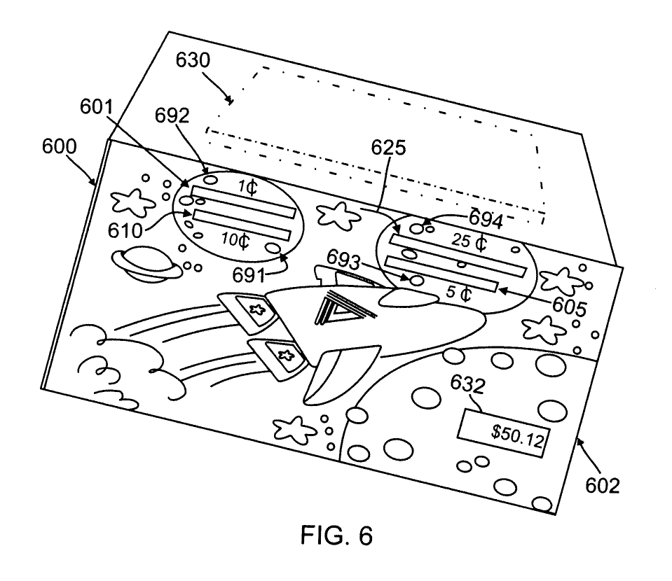

FIG. 6 illustrates a perspective view of a coin bank 600 having multiple coin deposit slots and an integrated electronics board 630 in accordance with one embodiment of the present invention. The coin bank 600 has a rectangular box like shape with a top surface 602 that includes four coin deposit slots including a one cent (penny) 601, a five cent (nickel) 605, a ten cent (dime) 610 and a twenty-five cent (quarter) 625 slot. Each coin deposit slot has at least one corresponding light emitting diode (LED). In the illustrated embodiment, LED 692 corresponds to the one-cent slot 601, LED 693 corresponds to the five-cent slot 605, LED 691 corresponds to the ten-cent slot 610 and LED 694 corresponds to the twenty-five cent slot 625. In other embodiments, any number of deposit coin slots can be used. In such case, any number of LEDs can be used in conjunction with the deposit coin slots. The integrated electronics board 630 can be mounted within the coin bank 600. The coin bank can be made from any number of materials, including metal, metal composites, plastic and/or other suitable materials.

In operation, a user deposits one or more coins into the coin bank. In response, the coin bank can activate the LED corresponding to the coin deposited and add the monetary amount to the stored coin bank total savings. In several embodiments, the integrated electronics board 630 responds when a coin is deposited into the coin bank.

In one embodiment, the coin bank includes a display 632 that indicates the current value of money stored in the bank. In one embodiment, the display includes a number of lighted segments capable of displaying any number of numerical digits.

In another embodiment, the body of the coin bank includes reference to a website. In such case, the website can provide an interface allowing a coin bank user to keep a record of their savings. In one embodiment, the coin bank includes a computer interface (e.g. USB) that enables the user to connect the coin bank to a computer and enables the coin bank to relay stored information relating to stored coins to the website or another computer program.

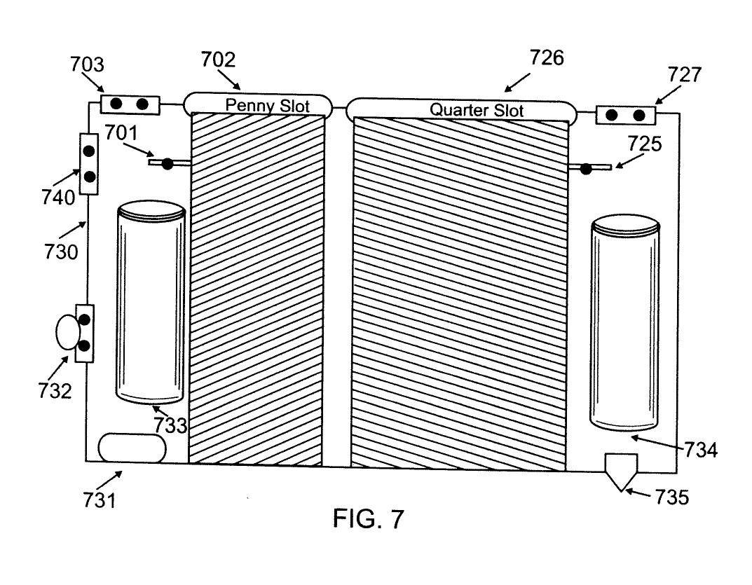

FIG. 7 illustrates a front view of the integrated electronics board of FIG. 6. The integrated electronics board 730 can be mounted within a coin bank, as illustrated in FIG. 6. The integrated electronics board 730 includes a one-cent (penny) slot 702, a twenty-five cent (quarter) slot 726, a penny LED 703, a quarter LED 727, a penny actuator sensor 701, a quarter actuator sensor 725, a speaker device 732, a summing register reset 731, a summing register 735, an electrical component area 733, an electrical component area 734, and an optional actuator sensor 740. The penny actuating sensor 701 can be triggered and penny LED 703 illuminated when a penny or other suitable coin is deposited into the penny slot 702. Similarly, quarter actuating sensor 725 can be triggered and quarter LED 727 illuminated when a quarter or other suitable coin is deposited into quarter slot 726.

The penny slot 702 and quarter slot 726 are shown as being on the front side of the integrated electronics board 730 but can be located on either side of the board. Additional electronic components of the integrated electronics board 730 are located in the areas shown as 733 and 734. The optional actuator sensor 740 can be triggered by an external button mounted on the coin bank. The speaker device 732 is mounted to integrated electronics board 730. A DC battery (not shown) can power the integrated electronics board 730 and can be mounted within the coin bank. The summing register reset 735 can be mounted within the coin bank.

In one embodiment, the integrated electronics board is a printed circuit board (PCB). In another embodiment, the front side of the integrated electronics board can include slots for other sizes or types of coins. In addition, the front side of the integrated electronics board can include less than or more than two coin slots. In one embodiment, the integrated electronics board can include a microprocessor, a microcontroller, a memory, programmable logic devices, discrete logic components and/or other components suitable for enabling the operation of the coin bank.

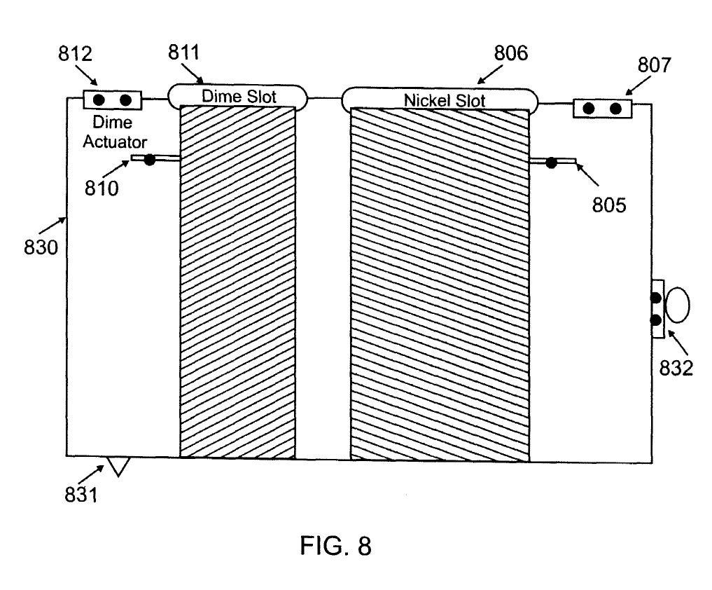

FIG. 8 illustrates a back view of the integrated electronics board of FIG. 6. The integrated electronics board 830 can be mounted within a coin bank, as illustrated in FIG. 6. The integrated electronics board 830 includes a dime slot 811, a dime actuator sensor 810, a dime LED 812, a nickel slot 806, a nickel actuator sensor 805, a nickel LED 807, a speaker device 832 and a summing register reset input 831.

When a dime or other appropriately sized coin is deposited into the dime slot 811, the dime actuating sensor 810 can be triggered and dime LED 812 illuminated. Similarly, when a nickel or other appropriately sized coin is deposited into quarter slot 806, the nickel actuating sensor 805 can be triggered and nickel LED 806 illuminated.

The dime slot 811 and nickel slot 806 are shown as being on the rear of the integrated electronics board but can be located on either side of the board. The speaker device 812 is mounted to integrated electronics board 830. The summing register reset 831 can be mounted within the coin bank.

In one embodiment, the rear of the integrated electronics board can include slots for other sizes or types of coins. In addition, the back side of the integrated electronics board can include less than or more than two coin slots. In one embodiment, the integrated electronics board can include a microprocessor, a microcontroller, a memory, programmable logic devices, discrete logic components and/or other components suitable for enabling the operation of the coin bank.

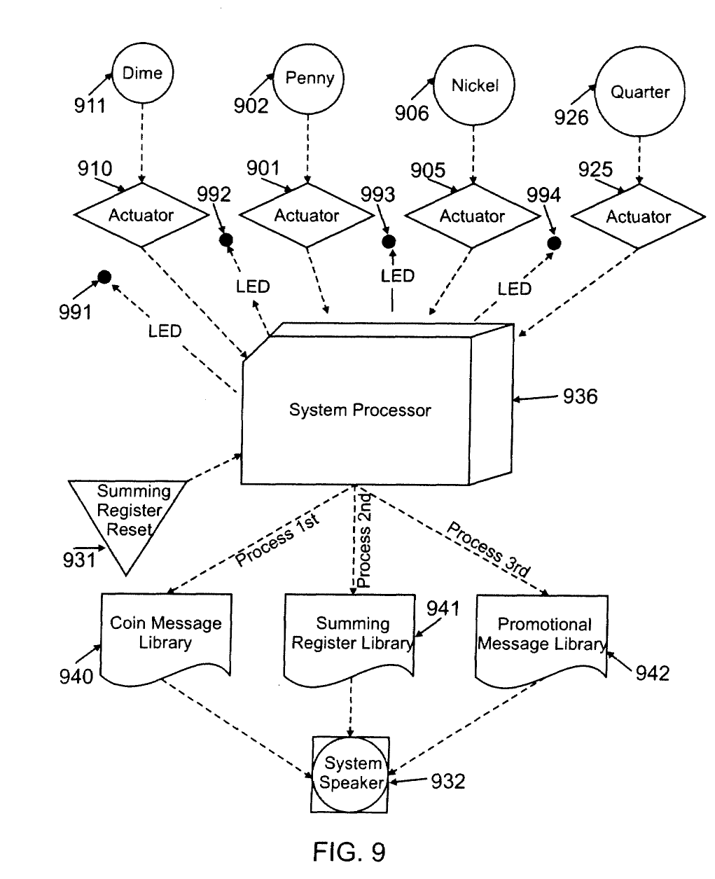

FIG. 9 is a flowchart illustrating the operation of the integrated electronics board of FIG. 6 in accordance with one embodiment of the present invention. In the operation of the integrated electronics board, four types of coins can be deposited, including a dime 911, a penny 902, a nickel 906 and a quarter 926. For simplicity, the operation of the integrated electronics board for a single denomination coin, the dime 911, is described. The operation of the board with respect to the dime can be typical of the operation of the board for any of the coins dropped into a respective coin deposit slot.

In operation, a dime 911 can be deposited into the coin bank dime slot. As gravity causes the dime 911 to fall within the bank, it makes contact with a dime actuator sensor 910. This contact with the dime actuator sensor 910 initiates a chain of events. The dime actuator sensor 910, having been triggered by the deposit of the dime 911, is recognized as being in an active state by the system processor 936. The system processor 936 identifies the particular actuator sensor that was triggered. A predetermined monetary value is stored with respect to each of the actuator sensors present on the device and is programmed into the logic of the electronics. This value can be a whole number or a decimal and can range from a zero value to any number of decimals. In this example, the dime sensor 910 was triggered and thus the summing register 936, implemented within the electronics in this case, is increased by the respective value associated with the deposited coin, in this case ten cents. The current value of the summing register 936 is maintained unless the summing register reset 931 is activated, at which time the value of the summing register 936 is reset to zero. When the dime actuator is tripped, the system processor 936 causes the LED 991, assigned to that particular coin slot, to emit light in either a continuous manner for a specified period of time or to blink in some defined sequence.

Continuing with the example, the system processor 936 also accesses a number of audible message libraries contained within the system electronics. For purposes of this example, these audible message libraries have been defined as the Coin Message Library 940, the Summing Register Library 941 and the Promotional Message Library 942. Other audible libraries can be defined within the system architecture. The system processor 936 selects the appropriate message from each library, sequences the messages and audibly announces the messages in the sequence defined by the system architecture.

A net result of this example is that the deposit of a dime 911 into the coin bank triggers the actuator sensor 910, which alerts the system processor 936 to the deposit activity. The system processor 936 positively increments the summing register and updates the summing register library 941. A series of audible messages are then retrieved from the appropriate libraries and audibly broadcasted using the system speaker 932. Typical audible messages for such a transaction might include, “You have just deposited ten cents into your coin bank (from coin message library), “You now have four dollars and fifty cents in the bank (from summing register library), and/or “Thanks for saving with Arizona Federal Savings (from promotional message library)”. In one embodiment, the coin bank includes a button or other input device that allows the user to replay the audible message(s). These audible sounds are described in detail in U.S. Provisional Patent App. No. 60/379,845, the entire content of which is incorporated herein by reference.

In another embodiment, the electronic circuits determine the value of the coins or currency deposited and issue an audible message indicating the value of the deposited coins or other currency. For example, in one embodiment, the bank can issue a message such as, “Thank you for depositing ten cents” after the user deposits a dime. In addition, as discussed above, the bank can track the total value of currency deposited in the bank, and emit an audible message describing the total value of the currency accumulated since the bank register was last reset. Providing this information prevents the user from having to manually count deposited currency to ascertain the total value. In an alternate embodiment, the user can press a switch on the bank, which prompts the bank to emit a message indicating the total value of currency deposited since the bank register was last reset. In this embodiment, the user can ascertain the value stored in the bank without having to open the bank. In addition, hearing the total value deposited can encourage the user to save further.

In another embodiment of the present invention, the bank includes electronic circuitry for issuing a light display activated by the deposit of coins or currency, or by activation of a separate switch.

In the same fashion that the audible message can be invoked, the electronics of the bank can also control the activation of LEDs 991, 992, 993 and 994 shown in the illustration. These LEDs can be activated in a defined sequence or pattern depending upon instructions contained with the coin bank electronics. In one embodiment of this invention, the blinking of the LEDs is not a random pattern but is rather a defined pattern that corresponds to the value of a particular coin deposited into the coin bank. These LEDs 991, 992, 993, 994 can be flashed in series or in parallel depending upon the programming contained within the electronics of the saving bank.

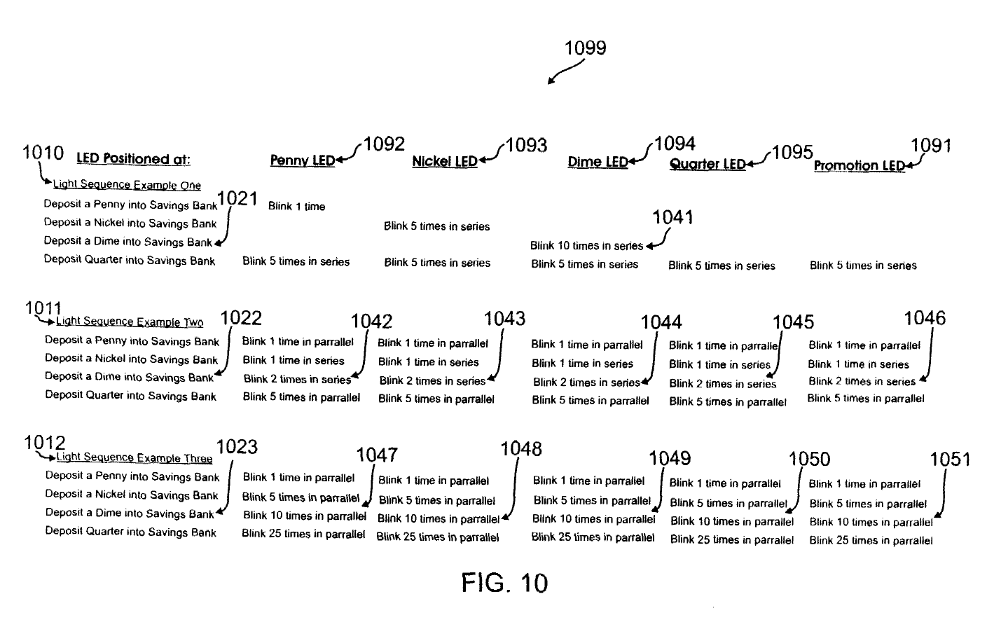

FIG. 10 is a table illustrating sequences by which the LEDs of FIG. 9 can be controlled to emit light. The table 1099 includes three different light sequence examples using five LEDs 1092, 1093, 1094, 1095 and 1091. In each case, a common factor is that the pattern of the LEDs 1092, 1093, 1094, 1095 and 1091 can represent the value of the coin deposited, in this example, a dime 1094.

For light sequence example one (1010), the electronics of the coin bank has recognized that a dime 1021 has been deposited into the bank. In such case, the integrated electronics board responds by issuing a set of blink commands 1041 to the dime LED 1094 that result in the blinking of the dime LED 1094 ten times in series. This can reinforce the counting concept to the user of the bank.

For light sequence example two (1011), the electronics of the coin bank has recognized that a dime 1022 has been deposited into the dime slot of the bank. In this example, the electronics respond by issuing a set of blink commands 1042, 1043, 1044, 1045, 1046 to the LEDs 1091, 1092, 1093, 1094, 1095, which produce a serial blinking for each LED two times each in series. This also can reinforce the counting concept to the user of the bank.

For light sequence example three (1012), the electronics of the coin bank has recognized that a dime 1023 has been deposited into the bank. In this example, the programming of the electronics responds by issuing a set of blink commands 1047, 1048, 1049, 1050, 1051 to LEDs 1091, 1092, 1093, 1094, 1095 that produce blinking of each LED ten times in parallel. This again can reinforce the counting concept to the user of the bank. These light displays are described in detail in U.S. Provisional Pat. App. No. 60/498,789, the entire content of which is incorporated herein by reference.

When coins or currency are deposited into the bank, the electronic circuitry provides a visible display of lights on the bank exterior. The light display can indicate the value of currency just deposited or the total value of currency contained in the bank. For example, in one embodiment, the light display can indicate the total value of currency deposited since the bank register was last reset. In an alternative embodiment, the user can activate the light display by pressing a separate switch. In such an embodiment, the light display indicates the total value of currency deposited since the bank register was last reset. Informing the user of the value of currency stored within the bank prevents the user from having to open the bank to ascertain the value within the bank.

While the above description contains many specific embodiments of the invention, these should not be construed as limitations on the scope of the invention, but rather as examples thereof. Accordingly, the scope of the invention should be determined not by the embodiments illustrated, but by the appended claims and their equivalents.

What is claimed is:

1. A coin bank for storing money, comprising:
a vessel configured to store at least one coin, where the vessel includes an opening;
a receiving means for receiving the at least one coin in a first position, the receiving means having a first hinge at a first end and a second hinge at a second end; and
an actuating means for moving the receiving means from the first position to a second position, the actuating means in contact with the receiving means and the vessel;
wherein the opening is configured to receive the at least one coin in the second position.

2. The coin bank of claim 1:
wherein the first hinge is fixed and the second hinge is configured to be moved by the actuating means.

3. The coin bank of claim 1, wherein the receiving means is a receptacle plate.

4. The coin bank of claim 3, further comprising a second plate having a first end and a second end, the first end of the second plate coupled to the second hinge.

5. The coin bank of claim 4, wherein the second end of the second plate is coupled to an articulating hinge.

6. The coin bank of claim 4:
wherein the second plate further comprises a release button; and
wherein the actuating means is configured to move the receiving means from a first position to a second position when the release button is pressed.

7. The coin bank of claim 1:
wherein the receiving means further comprises a release button; and
wherein the actuating means is configured to move the receiving means from a first position to a second position when the release button is pressed.

8. The coin bank of claim 1, further comprising a means for receiving paper currency coupled to a second vessel for storing paper currency.

9. The coin bank of claim 1, further comprising:
a means for counting the at least one coin; and
a means for storing a count of the at least one coin.

10. The coin bank of claim 9, further comprising a means for notifying a user of a value of the count.

11. The coin bank of claim 10, wherein the means for notifying the user includes at least one of a visual display, an LED, and a sound generating device.

12. The coin bank of claim 1, further comprising a means for alerting a user when the at least one coin is received, the means for alerting the user including at least one of an audio indication and a visual indication.

13. The coin bank of claim 1, wherein the receiving means comprises at least one coin cylinder configured to receive the at least one coin.

14. A coin bank for storing money, comprising:
a vessel configured to store at least one coin, where the vessel includes an opening;
a receiving means for receiving the at least one coin in a first position, the receiving means having a first hinge at a first end;
a means for receiving paper currency; and
an actuating means for moving the receiving means from the first position to a second position, the actuating means in contact with the receiving means and the vessel;
wherein the opening is configured to receive the at least one coin in the second position.

15. The coin bank of claim 14:
wherein the receiving means is a receptacle plate and the first hinge is coupled to the vessel.

16. The coin bank of claim 14:
wherein receiving means comprises a release button; and
wherein the actuating means is configured to move the receiving means from a first position to a second position when the release button is pressed.

17. The coin bank of claim 14, further comprising:
a means for counting the at least one coin; and
a means for storing a count of the at least one coin.

18. The coin bank of claim 17, further comprising a means for notifying a user of a value of the count.

19. The coin bank of claim 18, wherein the means for notifying the user includes at least one of a visual display, an LED, and a sound generating device.

20. The coin bank of claim 19, further comprising a means for alerting a user when the at least one coin is received, the means for alerting the user including at least one of an audio indication and a visual indication.

21. The coin bank of claim 14, wherein the receiving means comprises at least one coin cylinder configured to receive the at least one coin.

22. A method for storing money in a coin bank, the method comprising:
providing a vessel configured to store at least one coin;
providing a receiving means configured to receive the at least one coin, the receiving means having a first hinge and a second hinge;
moving the receiving means from a first position to a second position to deposit the at least one coin into the vessel;
wherein the moving the receiving means comprises moving the first hinge from a third position to a fourth position; and
wherein the moving the receiving means comprises moving the second hinge from a fifth position to a sixth position.

23. A coin bank for storing money, comprising:
a vessel configured to store at least one coin, where the vessel includes an opening;
a receiver configured to receive the at least one coin in a first position, the receiver having a spring biased hinge at a first end and a moveable hinge at a second end, wherein the spring biased hinge is coupled to the receiver and the vessel and is configured to move the receiver from the first position to a second position;
wherein the opening is configured to receive the at least one coin in the second position.

24. The coin bank of claim 23:
wherein the receiver comprises a first receptacle plate extending from the spring biased hinge to the moveable hinge, and a second receptacle plate having a first end and a second end, the first end of the second plate being coupled to the moveable hinge.

25. A coin bank for storing money, comprising:
a vessel configured to store at least one coin, where the vessel includes an opening;
a first receiver for receiving the at least one coin in a first position, the receiver having a spring biased hinge at a first end, the spring biased hinge being coupled to the vessel and being configured to move the first receiver from the first position to a second position;
a second receiver for receiving paper currency; and
wherein the opening is configured to receive the at least one coin in the second position.
